(19) United States
(12) Patent Application Publication
(10) Pub. No.: US 2009/0225009 A1
(43) Pub. Date: Sep. 10, 2009

(54) Organic light emitting display device and associated methods

(76) Inventor: Ji-Hyun Ka, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/379,860

(22) Filed: Mar. 3, 2009

(30) Foreign Application Priority Data
Mar. 4, 2008 (KR) 10-2008-0020023

(51) Int. Cl. G09G 3/30

(52) U.S. Cl. 345/76

(57) ABSTRACT

An organic light emitting display device, includes a pixel unit including a plurality of pixels, a data driver adapted to supply a data signal to data lines, a data distributor, coupled between the data driver and the data lines, adapted to distribute the data signal from output lines of the data driver and respectively output the distributed data signals to the data lines, wherein each of the data lines coupled to the data distributor is coupled to a plurality of sub data lines associated with a corresponding column of the pixels, and a switch unit coupled between the data lines and the sub data lines and adapted to receive the distributed data signals from the data distributor and selectively output the respective distributed data signal to each of the sub data lines.

### BACKGROUND

1. Field

Embodiments relate to an organic light emitting display device and associated methods. More particularly, embodiments relate to organic light emitting display devices and methods capable of stably ensuring the driving time of pixels.

2. Description of the Related Art

In recent years, various flat panel displays that are lighter in weight and smaller in size than cathode ray tubes have been developed. Among the flat panel display devices, organic light emitting display devices have come into a spotlight as next-generation display devices since the organic light emitting display devices generally have relatively better luminance and color purity. Organic light emitting display devices employ organic compound as a light emitting material.

An organic light emitting display device may be relatively thin, light-weight and driven with relatively low power consumption. Therefore, organic light emitting display devices may be widely used, e.g., in the field of portable display devices, etc.

A data distributor may be used in an organic light emitting display device. More particularly, for large organic light emitting display devices, employing a data distributor may enhance resolution of the display. The data distributor may be coupled between a data driver and data lines of the organic light emitting display device. The data distributor may distribute a data signal supplied from the data driver and may output the distributed data signal.

More particularly, the data distributor may function to reduce a number of output lines in the data driver. The data distributor may accordingly divide a data signal and supply respective data signals to data lines of a large number of pixels, including, e.g., red, green, and blue subpixels. The data signal may be output from the output lines of the data driver.

Clock signals, e.g., red, green, and blue clock signals, for driving the data distributor are supplied to the data distributor prior to supplying a scan signal that controls the supply of a data signal to pixels.

As the scan signal and clock signals of the data distributor are supplied during a first horizontal period and are supplied so as to not overlap with each other, i.e., the clock signals of the data distributor are supplied before the scan signal for the horizontal period, there is a limit to a driving time for supplying the scan signal and the clock signals of the data distributor.

In particular, in a large organic light emitting display device having enhanced resolution, the first horizontal period is shortened with the increasing number of scan lines, leading to a more serious limitation on the above-mentioned driving time. Therefore, problems in stably driving the pixels may arise.

### SUMMARY

Embodiments are therefore directed to organic light emitting display devices and methods that substantially overcome one or more of the problems due to the limitations and disadvantages of the related art.

It is therefore a feature of an embodiment to provide an organic light emitting display device and method capable of stably ensuring the driving time of pixels and a data distributor employed therein.

It is therefore a separate feature of an embodiment to provide a relatively large-size and/or enhanced/high resolution organic light emitting display device, which includes a plurality of pixels and a data distributor, that is capable of ensuring a driving time of the pixels and the data distributor by supplying a data signal to sub data lines using the data distributor and a switch unit during a reset period when a scan signal is supplied to a previous scan line to reset the pixels by coupling the pixels in continuous rows to the different sub data lines.

At least one of the above and other features and advantages of aspects of the invention may be realized by providing an organic light emitting display device, including a pixel unit including a plurality of pixels, a data driver adapted to supply a data signal to data lines, a data distributor coupled between the data driver and the data lines and adapted to distribute the data signal from output lines of the data driver and respectively output the distributed data signals to the data lines, wherein each of the data lines coupled to the data distributor is coupled to a plurality of sub data lines associated with a corresponding column of the pixels, and a switch unit coupled between the data lines and the sub data lines and adapted to receive the distributed data signals from the data distributor and selectively output the respective distributed data signal to each of the sub data lines.

The pixels of a same row may be coupled to a same respective one of the sub data lines of each of the data lines, respectively, and pixels of adjacent rows may be coupled to different respective ones the sub data lines of each of the data lines.

Each of the data lines may be divided into first and second sub data lines, and rows of the pixels are alternately coupled to the first and second sub data lines.

The switch unit may include a plurality of switches coupled to each of the data lines to selectively couple each of the data lines to the plurality of corresponding ones of the sub data lines.

Each of the data lines is divided into first and second sub data lines, wherein the switch unit includes first switches coupled between each of the data lines and the respective first sub data line; and second switches coupled between each of the data lines and the respective second sub data line.

A frequency of a first control signal to commonly control the first switches and a frequency of a second control signal to commonly control the second switches each may be set to a second horizontal period, and the first and second control signals may have opposite waveforms.

Pixels disposed in a k^{th} (k is an integer) row are coupled to a k^{th} scan line (a current scan line) and a k-1^{st} scan line (a previous scan line), and further coupled to a first one of the sub data lines of each of the data lines, wherein an adjacent upper row and/or an adjacent lower row of the pixels may each be coupled to respective ones of the sub data lines of each of the data lines other than the first sub data lines.

Pixels disposed in the k^{th} row may be reset when a scan signal is supplied to the k-1^{st} scan line, and may receive the respective distributed data signal from the respective sub data lines coupled to the pixels in the k^{th} row when a scan signal is supplied to the k^{th} scan line.

The respective sub data lines coupled to the pixels disposed in the k^{th} row may receive the respective distributed data signal from the data driver via the data distributor and the switch unit during a period when a scan signal is supplied to the k-1^{st} scan line.

For each of the data signals supplied to the data distributor from the data driver, the data distributor may distribute the signal into a red data signal to be selectively supplied to a first column of the pixels, a blue data signal to be selectively supplied to a second column of the pixels and a green data signal to be selectively supplied to a third column of the pixels.

At least one of the above and other features and advantages of aspects of the invention may be separately realized by providing an organic light emitting display device including a plurality of scan lines, comprising a pixel unit including a plurality of pixels, a data driving mechanism for supplying a data signal to data lines, a data distributing mechanism for distributing the data signal from the data driving mechanism and respectively outputting the distributed data signals to the data lines, wherein each of the data lines is coupled to a plurality of sub data lines associated with a corresponding column of the pixels, and a switching mechanism for receiving the distributed data signal from the data distributor and selectively outputting the respective distributed data signal to each of the sub data lines.

The switching mechanism may enable a first group of the sub data lines to supply the respective distributed data signals to a corresponding first group of the pixels during a same period as when the respective distributed data signals associated with a second group of the pixels are supplied to a second group of the sub data lines associated with the second group of pixels.

At least one of the above and other features and advantages of aspects of the invention may be separately realized by providing a method of driving an organic light emitting display device, comprising a plurality of pixels, a plurality of scan lines adapted to receive scan signals and a data distributor, the method including supplying a data signal, distributing the data signal and respectively outputting the distributed data signals to data lines, wherein each of the data lines is coupled to a plurality of sub data lines associated with a corresponding column of the pixels, and selectively supplying the distributed data signals to a first group of the sub data lines associated with a first group of the pixels, during a same period, supplying a scan signal to a row of the pixels including the first group of pixels and selectively supplying the distributed data signals to a second group of the sub data lines associated with a second group of the pixels.

The first group of pixels may be a continuous row of pixels and the second group of pixels may be another continuous row of pixels that is adjacent to the first row of pixels.

The method may further include, during another period, supplying the scan signal to the second group of pixels and selectively supplying the distributed data signals to one of a third group or the first group of the sub data lines that is associated with a third group of pixels.

Distributing the data signal and respectively outputting the distributed data signals to data lines may include distributing the data signal in accordance with a plurality of clock signals.

### BRIEF DESCRIPTION OF THE DRAWINGS

The above and other features and advantages of the embodiments will become more apparent to those of ordinary skill in the art by describing in detail exemplary embodiments thereof with reference to the attached drawings, in which:

FIG. 1 illustrates a circuit diagram of a pixel according to one exemplary embodiment;

FIG. 2 illustrates an exemplary waveform diagram of an exemplary method for driving the pixel illustrated in FIG. 1;

FIG. 3 illustrates a waveform diagram of a method for driving an organic light emitting display device employing a data distributor together with the pixel illustrated in FIG. 1;

FIG. 4 illustrates a block diagram of an organic light emitting display device according to one exemplary embodiment; and

FIG. 5 illustrates an exemplary waveform diagram of an exemplary embodiment of a method for driving the organic light emitting display device illustrated in FIG. 4.

### DETAILED DESCRIPTION OF EMBODIMENTS

Korean Patent Application No. 10-2008-0020023, filed on Mar. 4, 2008, in the Korean Intellectual Property Office, and entitled: “Organic Light Emitting Display Device,” is incorporated by reference herein in its entirety.

Embodiments will now be described more fully hereinafter with reference to the accompanying drawings, in which exemplary embodiments are illustrated. Aspects of the invention may, however, be embodied in different forms and should not be construed as limited to the embodiments set forth herein. Rather, these embodiments are provided so that this disclosure will be thorough and complete, and will fully convey the scope of the invention to those skilled in the art.

Herein, when a first element is described as being coupled to a second element, the first element may be directly coupled to the second element or may be indirectly coupled to the second element via one or more other elements. Further, some of the elements that are not essential to the complete understanding of the embodiments are omitted for clarity. Also, like reference numerals refer to like elements throughout the specification.

FIG. 1 illustrates a circuit diagram of a pixel according to one exemplary embodiment. More particularly, FIG. 1 illustrates one example of a pixel that is configured to compensate for a threshold voltage of a drive transistor, as well as to reset the threshold voltage of the drive transistor in effective manner. Also, the common configuration of subpixels, e.g., red, green and blue pixels, constituting one unit pixel is shown in FIG. 1 without any distinction of the subpixels. However, embodiments are not particularly limited thereto.

Referring to FIG. 1, in embodiments, the pixel may include an organic light emitting diode (OLED) and a pixel circuit 10. The pixel circuit 10 may supply an electric current to the organic light emitting diode (OLED).

An anode electrode of the organic light emitting diode (OLED) may be coupled to the pixel circuit 10. A cathode electrode of the organic light emitting diode (OLED) may be coupled to a second pixel power source (ELVSS). Such an organic light emitting diode (OLED) may emit light with luminance corresponding to an electric current capacity supplied from the pixel circuit 10.

The pixel circuit 10 may include first to sixth transistors (T1, T2, T3, T4, T5 and T6) and a storage capacitor (Cst). In the exemplary embodiments, the first to sixth transistors (T1, T2, T3, T4, T5 and T6) are illustrated as p-type transistors that may be turned on when a LOW level signal is supplied to a gate electrode thereof. Further, herein, a scan signal may be considered as supplied when it is at a LOW level and not supplied when it is at a HIGH level, and a light emitting control signal may be considered as supplied when it is at a HIGH level and not supplied when it is at a LOW level. Embodiments are not, however, limited to thereto. For example, the pixel circuit may employ n-type transistors.

The first transistor (T1) may be coupled between a data line (Dm) and a first node (N1). A gate electrode of the first transistor (T1) may be coupled to a current scan line (Sn). The first transistor (T1) may be turned on, e.g., when a scan signal having a LOW level is supplied to the current scan line (Sn). When the first transistor (T1) is turned on, a data signal may be supplied from the data line (Dm) to a first node (N1).

The second transistor (T2) may be coupled between the first node (N1) and the organic light emitting diode (OLED). A gate electrode of the second transistor (T2) may be coupled to the second node (N2). The second transistor (T2) may control the capacity of an electric current flowing from the first node (N1) to the organic light emitting diode (OLED) to correspond to the data signal supplied to the pixels when a scan signal is supplied to the current scan line (Sn).

The third transistor (T3) may be coupled between the gate electrode and a drain electrode of the second transistor (T2). A gate electrode of the third transistor (T3) may be coupled to the current scan line (Sn). The third transistor (T3) may be turned on when a scan signal is supplied, e.g., the scan signal has a LOW level, to the current scan line (Sn). When the third transistor (T3) is turned on, the second transistor (T2) may be in a diode-connected state.

The fourth transistor (T4) may be coupled between the second node (N2) and a reset power source (Vinit). A gate electrode of the fourth transistor (T4) may be coupled to a previous scan line (Sn-1). The fourth transistor (T4) may be turned on when a scan signal is supplied, e.g., the scan signal has a LOW level, to the previous scan line (Sn-1). When the fourth transistor (T4) is turned on, the second node (N2) may be reset.

The fifth transistor (T5) may be coupled between a first pixel power source (ELVDD) and the first node (N1). A gate electrode of the fifth transistor (T5) may be coupled to a light emitting control line (En). The fifth transistor (T5) may be turned off when a light emitting control signal having a HIGH level is supplied to the light emitting control line (En). When the fifth transistor (T5) is turned off, a voltage from the first pixel power source (ELVDD) may not be supplied to the first node (N1) and the organic light emitting diode (OLED), and thus, the pixel may not emit light. Further, the fifth transistor (T5) may be turned on when a light emitting control signal having a LOW level is supplied to the light emitting control line (En), i.e., when the polarity of the light emitting control line (En) is at a LOW level. When the fifth transistor (T5) is turned on, a voltage from the first pixel power source (ELVDD) may be supplied to the first node (N1).

The sixth transistor (T6) may be coupled between the second transistor (T2) and the organic light emitting diode (OLED). A gate electrode of the sixth transistor (T6) may be coupled to the light emitting control line (En). The sixth transistor (T6) may be turned off when a light emitting control signal having a HIGH level is supplied to the light emitting control line (En). When the sixth transistor (T6) is turned off, an electric current may not be supplied from the second transistor (T2) to the organic light emitting diode (OLED). The sixth transistor (T6) may be turned on when a light emitting control signal having a LOW level is supplied to the light emitting control line (En), i.e., when the polarity of the light emitting control line (En) is at a LOW level. When the sixth transistor (T6) is turned on, an electric current may be transmitted from the second transistor (T2) to the organic light emitting diode (OLED).

The storage capacitor (Cst) may be coupled between the first pixel power source (ELVDD) and the second node (N2). The storage capacitor (Cst) may be reset by the reset power source (Vinit) when a scan signal is supplied to the previous scan line (Sn-1). The storage capacitor (Cst) may be charged with a voltage corresponding to the data signal when a scan signal is supplied to the current scan line (Sn-1).

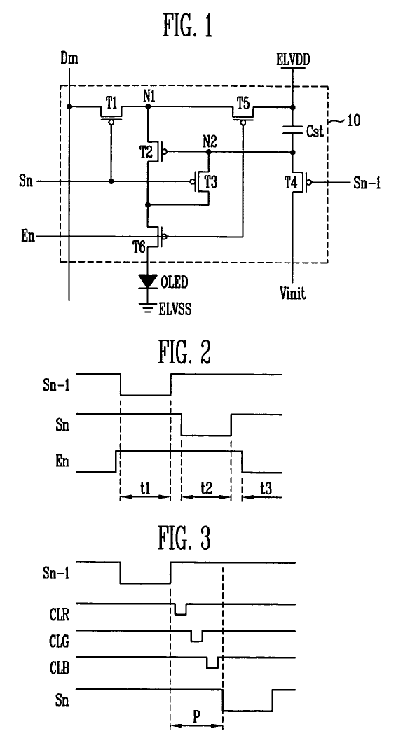

FIG. 2 illustrates an exemplary waveform diagram of an exemplary method for driving the pixel illustrated in FIG. 1. Hereinafter, an exemplary method for driving the exemplary pixel shown in FIG. 1 will be described in more detail with reference to FIGS. 1 and 2.

Referring to FIG. 2, during a first period t1, a scan signal having a LOW level is supplied to the previous scan line (Sn-1). Accordingly, the fourth transistor (T4) is first turned on to reset the second node (N2). Also, during the first period t1, a light emitting control signal having a HIGH level may be supplied to the light emitting control line (En). Accordingly, the fifth and sixth transistors (T5 and T6) are turned off. Accordingly, supply of a fault current to the organic light emitting diode (OLED) may be prevented.

Then, during a second period t2, supply of a scan signal having a LOW level to the previous scan line (Sn-1) may be suspended, e.g., the scan signal supplied to the previous scan line (Sn-1) may change from a LOW level to a HIGH level, and a scan signal having a LOW level may be supplied to a current scan line (Sn-1) during the second period t2 period. Accordingly, during the second period t2, the fourth transistor (T4) may be turned off, and the first and third transistors (T1 and T3) may be turned on. When the first transistor (T1) is turned on, a data signal supplied from the data line (Dm) may be supplied to the first node (N1). When the third transistor (T3) is turned on, the second transistor (T2) may be in a diode-connected state. In such a state, a data signal supplied to the first node (N1) may be supplied to the second node (N2) via the second and third transistors (T2 and T3). At this time, a voltage corresponding to the data signal and the threshold voltage of the second transistor (T2) may be charged in the storage capacitor (Cst).

Referring to FIG. 2, during a third period t3, supply of a scan signal to the current scan line (Sn) may be suspended, e.g., the scan signal supplied to the current scan line (Sn) may change from a LOW level to a HIGH level, and supply of a light emitting control signal to the light emitting control line (En) is also suspended, e.g., the light emitting control signal supplied to the light emitting control line (En) may change from a HIGH level to a LOW level. When the polarity of the light emitting control line (En) becomes a LOW level, the fifth and sixth transistors (T5 and T6) are turned on. When the fifth transistor (T5) is turned on, the first pixel power source (ELVDD) may be supplied to the first node (N1). When the sixth transistor (T6) is turned on, an electric current from the second transistor (T2) may be transmitted to the organic light emitting diode (OLED). The electric current flowing to the organic light emitting diode (OLED) may correspond to a voltage supplied to a gate electrode of the second transistor (T2), e.g., may correspond to a voltage charged in the storage capacitor (Cst).

At this time, a voltage corresponding to the threshold voltage of the second transistor (T2) may be charged in the storage capacitor (Cst) together with the data signal supplied during the second period t2. Therefore, an effect on the threshold voltage of the second transistor (T2) may be offset during the third period t3. Therefore, a constant electric current may flow in the organic light emitting diode (OLED) regardless of the threshold voltage of the second transistor (T2).

Then, the organic light emitting diode (OLED) may display an image by emitting light having a luminance corresponding to an electric current capacity supplied to the organic light emitting diode (OLED).

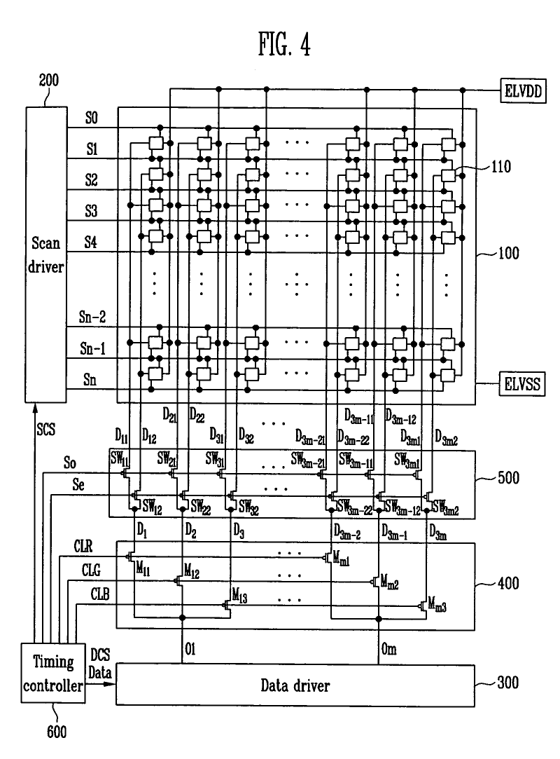

FIG. 3 illustrates a waveform diagram of a method for driving an organic light emitting display device employing a data distributor together with the pixel illustrated in FIG. 1.

In general, an organic light emitting display device employing, e.g., the exemplary pixel described above in connection with FIGS. 1 and 2 and a data distributor, is designed so that clock signals of the data distributor and scan signals of the scan lines (e.g., S1 to Sn) do not overlap with each other.

More particularly, such lack of overlap allows the data lines (e.g., D1 to Dm) to be precharged by supplying clock signals, e.g., red, green, and blue clock signals (CLR, CLG and CLB), of the data distributor prior to supplying a data signal to the pixels by supplying a scan signal to the current scan line (Sn). When the pixels arranged in one column share one data line, clock signals (CLR, CLG, and CLB) of the data driver may not be supplied during a period that a scan signal is supplied to the previous scan line (Sn-1).

Therefore, referring to FIG. 3, the clock signals (CLR, CLG, and CLB) of the data distributor may be supplied only during a period (P) between the periods that scan signals are supplied. More particularly, referring to FIG. 3, the clock signals (CLR, CLG, and CLB) may be supplied by dividing a portion of time of a first horizontal period during which a scan signal is not supplied. That is, the scan signal and the clock signals (CLR, CLG, and CLB) of the data distributor may be supplied so as not to overlap with each other during the first horizontal period. In such cases, however, there may be a limit to a driving time for supplying the scan signal and the clock signals (CLR, CLG, and CLB) of the data distributor.

However, when the organic light emitting display device has particular characteristics, e.g., a relatively large size and/or a relatively high/enhanced resolution, the first horizontal period may be shortened due to an increasing number of scan lines. In such cases, there may be a more serious limitation on the above-mentioned driving time. Therefore, it may be difficult to stably drive the pixels and the data distributor with a method in which the clock signals (e.g., CLR, CLG, and CLB) of the data distributor are supplied only during a period between the periods that scan signals are supplied.

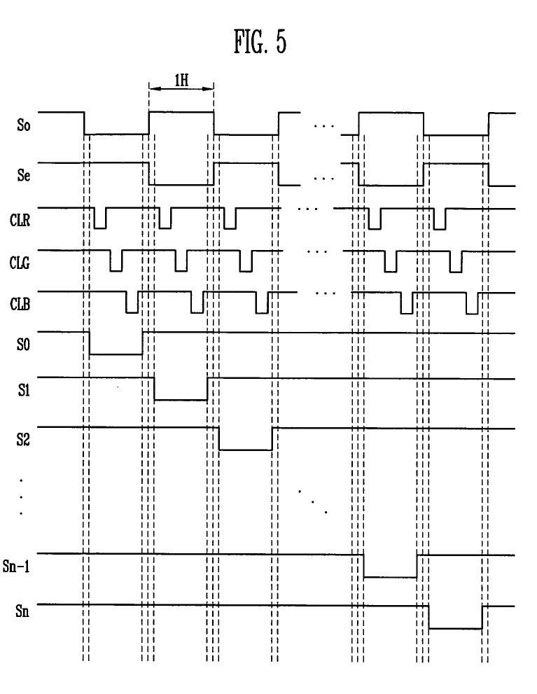

Therefore, in order to stably ensure a driving time of pixels and a data distributor of an organic light emitting display device, embodiments may provide an organic light emitting display device in which clock signals (e.g., CLR, CLG, and CLB) of the data distributor may overlap with scan signals. More particularly, embodiments may provide organic light emitting display devices in which supply of clock signals of the data distributor may overlap with supply of scan signals, e.g., clock signals of the data distributor may be at LOW level while scan signals are at a LOW level. The exemplary configuration of an exemplary organic light emitting display device according to an exemplary embodiment will be described in more detail with reference to FIGS. 4 and 5.

FIG. 4 illustrates a block diagram of an exemplary organic light emitting display device according to one exemplary embodiment.

Referring to FIG. 4, the organic light emitting display device may include a pixel unit 100, a scan driver 200, a data driver 300, a data distributor 400, a switch unit 500, and a timing controller 600.

Referring to FIG. 4, the organic light emitting display device may include a pixel unit 100 including a plurality of pixels 110 arranged in a matrix type manner. That is, e.g., the pixel unit 100 may include a plurality of rows (1 to n) and a plurality of columns (1 to m) and each pixel 110 may be arranged at an intersection of a respective row and column of the pixel unit 100.

The pixel unit 100 may include a plurality of scan lines (S0 to Sn) and may be associated with a plurality of data lines (D1 to D3m). More particularly, the pixel unit 100 may include n+1 scan lines such that each of the plurality of pixels 110 may be associated with, e.g., two respective adjacent ones of the scan lines (S0 to Sn) and a respective one of the data lines (D1 to D3m).

Referring to FIG. 4, the data driver 300 may include a plurality of output lines O1 to Om. Each of the output lines O1 to Om may supply a signal associated with respective subpixels of unit pixels, e.g., a signal that may drive the red, green and blue subpixels of respective unit pixels. Each subpixel may correspond to the exemplary pixel illustrated in FIG. 1.

More particularly, e.g., in the exemplary embodiment illustrated in FIG. 4, each of the pixels 110 may correspond to a subpixel and every three adjacent pixels 110 may be considered a unit pixel.

In the exemplary embodiment illustrated in FIG. 4, each output line (O1 to Om) may be employed to supply a data signal to three corresponding data lines, e.g., red, green and blue subpixel columns, of the organic light emitting display device. For example, the first output line (O1) may be employed to supply respective data signals to three corresponding data lines (D1, D2, D3) and the mth output line (Om) may be employed to supply respective data signals to three corresponding data lines (D3m-2, D3m-1, D3m). Each output line (O1 to Om) may supply respective data signals to the corresponding data lines (D1 to D3m) based on the clock signals (CLR, CLG, and CLB) of the data distributor 400.

More particularly, referring to FIG. 4, each of the data lines (D1 to D3m) may be associated with a plurality of sub data lines (D11 to D3m2). That is, e.g., in the exemplary embodiment illustrated in FIG. 4, each of the data lines (D1 to D3m) is associated with two sub data lines, e.g., the first data line (D1) is associated with two respective sub data lines (D11 and D12) and the 3m-1th data line (D3m-1) is associated with two respective sub data lines (D3m-1 and D3m-12). In the exemplary embodiment of FIG. 4, two sub data lines are illustrated for each data line (D1 to D3m), however, embodiments are not limited to two sub data lines.

In some embodiments, rows (1 to n) of the pixel unit 100 may be divided into two or more row groups (e.g., odd and even rows) and the pixels 110 in each row group may be associated with different respective ones of the sub data lines (D11 to D3m2). For example, in the exemplary embodiment illustrated in FIG. 4, the first sub data line (D11, D21, . . . D3m-21, D3m-11, D3m1) of each of the data lines (D1 to D3m) may be associated with one or more of the rows (1 to n) of the pixels 110 (e.g., the first, third, . . . and n−1th rows, i.e., the odd rows) and the second sub data line (D12, D22, . . . D3m-22, D3m-12, D3m2) of each of the data lines may be associated with one or more other rows (1 to n) of the pixels 110 (e.g., the second, fourth, . . . and nth rows, i.e., the even rows) in an alternating manner.

In some embodiments, e.g., each row (1 to n) of the pixels 110 of the pixel unit 100 may be associated with at least one of the sub data lines (D11 to D3m2) of each of the data lines (D1 to D3m). In the exemplary embodiment of FIG. 4, each row (1 to n) of the pixels 110 of the pixel unit 100 is illustrated as being associated with a same respective one (e.g., first or second one) of the sub data lines of each of the data lines (D1 to D3m) and each column (1 to m) of the pixels 110 of the pixel unit is illustrated as being associated with each of the sub data lines of the respective data lines (D1 to D3m). In some embodiments, e.g., a plurality of sub data lines (e.g., D11, D12, D21, D22, D31, D32) may be associated with a single column of unit pixels including, e.g., red, green, and blue subpixels. Embodiments are not limited to the configuration illustrated in FIG. 4. For example, each data line may be associated with four sub data lines and/or groupings of the pixels and sub data lines may be different.

In some embodiments, a pixel (hereinafter, referred to as a kj^{th} pixel) disposed in a k^{th} (k is an integer) row and a j^{th} (j is an integer) column may be coupled to the k^{th} scan line (current scan line, Sk) and one of the sub data lines (Dj1 and Dj2) of the j^{th} data line (Dj). Also, in embodiments in which the pixels 110, e.g., the exemplary pixel of FIG. 1, are configured to be reset when a scan signal is supplied to the previous scan line, the kj^{th} pixel may be coupled to a k-1^{st} scan line (the previous scan line, Sk-1).

The pixels 110 may be reset when a scan signal is supplied to the previous scan line (Sk-1). The sub data lines (D11, D21, . . . , and D3m1 or D12, D22, . . . , and D3m2), which are coupled to the pixels 110 reset during this period, may be precharged by the respective data signal that is supplied from the data driver 300 via the data distributor 400 and the switch unit 500.

Then, when a scan signal is supplied from the current scan line (Sk), the pixels 110 associated therewith may receive a data signal from the respective sub data lines (D11, D21, . . . , and D3m1 or D12, D22, . . . , and D3m2) that are coupled to the pixels 110.

The scan driver 200 may generate a scan signal based on the scan control signals (SCS) supplied from the timing controller 600. The scan signal generated in the scan driver 200 may be sequentially supplied to the scan lines (S0 to Sn).

The data driver 300 may generate a data signal to correspond to data (Data) and data control signals (DCS) supplied from the timing controller 600. The data signal generated in the data driver 300 may be supplied to the data distributor 400 through the output lines (O1 to Om) of the data driver 300.

The data distributor 400 may be coupled between the data driver 300 and the data lines (D1 to D3m). Such a data distributor 400 may output a data signal, which may be output from each of the output lines (O1 to Om) of the data driver 300, based on the clock signals (CLR, CLG, and CLB) supplied from the timing controller 600. The data distributor 400 may divide and respectively distribute the divided data signal to the plurality of data lines (D1 to D3m).

For example, the data distributor 400 may output the data signal output from each of the output lines (O1 to Om) of the data driver 300 by dividing the data signal into data lines (D1, D4, . . . , and D3m-2) of red pixels, data lines (D2, D5, . . . ; and D3m-1) of green pixels, and data lines (D3, D6, . . . , and D3m) of blue pixels.

For this purpose, the data distributor 400 may include first transistors (M11, M21, . . . , and Mm1), second transistors (M12, M22, . . . , and Mm2) and third transistors (M13, M23, . . . , and Mm3). While the first, second and third transistors (M11 to Mm3) in FIG. 4 are illustrated as p-type transistors, embodiments are not limited thereto. For example, the transistors may include n-type transistors.

Each of the first transistors (M11, M21, . . . , and Mm1) may be coupled between each of the output lines (O1 to Om) of the data driver 300 and the data lines (D1, D4, . . . , and D3m-2) of the red subpixels. Gate electrodes of the first transistors (M11, M21, . . . , and Mm1) may be coupled to input lines of the red clock signal (CLR) supplied from the timing controller 600. Such first transistors (M11, M21, . . . , and Mm1) may be turned on/off based on to the red clock signal (CLR).

The second transistors (M12, M22, . . . , and Mm2) may be coupled between each of the output lines (O1 to Om) of the data driver 300 and the data lines (D2, D5, . . . , D3m-1) of the green subpixels. Gate electrodes of the second transistors (M12, M22, . . . , and Mm2) may be coupled to input lines of the green clock signal (CLG) supplied from the timing controller 600. Such second transistors (M12, M22, . . . , and Mm2) may be turned on/off based on the green clock signal (CLG).

The third transistors (M13, M23, . . . , and Mm3) may be coupled between each of the output lines (O1 to Om) of the data driver 300 and the data lines (D3, D6, . . . , and D3m) of the blue subpixels. Gate electrodes of the third transistors (M13, M23, . . . , and Mm3) may be coupled to input lines of the blue clock signal (CLB) supplied to the timing controller 600. Such third transistors (M13, M23, . . . , and Mm3) may be turned on/off based on the blue clock signal (CLB).

The switch unit 500 may be coupled between the data distributor 400 and the sub data lines (D11, D12, D21, D22, . . . , D3m1, and D3m2). The switch unit 500 may include data lines, e.g., output lines (D1 to D3m) of the data distributor 400 and a large number of switches (SW11, SW12, SW21, SW22, . . . , SW3m1, and SW3m2) coupled between the sub data lines (D11, D12, D21, D22, . . . , D3m1, and D3m2) that are divided from the data lines (D1 to D3m). That is, the switch unit 500 may be composed of switches (SW11, SW12, SW21, SW22, . . . , SW3m1, and SW3m2) to selectively couple each of the data lines (D1 to D3m) to a plurality of the sub data lines (D11, D12, D21, D22, . . . , D3m1, and D3m2). The switch unit 500 may selectively supply the data signal, respectively supplied from each of the data lines (D1 to D3m), to the sub data lines (D11, D12, D21, D22, . . . , and D3m1, D3m2). While the switches (SW11, SW12, SW21, SW22, . . . , SW3m1, and SW3m2) in FIG. 4 are illustrated as p-type transistors, embodiments are not limited thereto. For example, the switches (SW11, SW12, SW21, SW22, . . . , SW3m1, and SW3m2) may include n-type transistors.

For example, the switch unit 500 may include first switches (SW11, SW21 . . . , and SW3m1) coupled between each of the data lines (D1 to D3m) and the first sub data lines (D11, D21, . . . , and D3m1) and second switches (SW12, SW22 . . . , and SW3m2) coupled between each of the data lines (D1 to D3m) and the second sub data lines (D12, D22, . . . , and D3m2). In some embodiments, the switch unit 500 may include a same number of switches as a number of sub data lines.

In some embodiments, during a period, the pixels 110 disposed in a same row may be reset at the same time and the data lines (D) may be precharged. During a subsequent period, respective data signals may be supplied to the pixels 110 in the same row associated with the current scan line 110. The respective data signals may be supplied to the corresponding pixels 110 at the same time. As discussed above, in the exemplary embodiment of FIG. 4, the pixels 110 disposed in a same row may be coupled to one of the first sub data lines (D11, D21, . . . , and D3m1) or the second sub data lines (D12, D22, . . . , and D3m2).

Therefore, control electrodes (gate electrodes) of the first switches (SW11, SW21 . . . , SW3m1) may be coupled to input lines of the same control signal. For example, the control electrodes of the first switches (SW11, SW21 . . . , SW3m1) may be coupled to an input line of the first control signal (So) supplied from the timing controller 600. Also, control electrodes (gate electrodes) of the second switches (SW12, SW22 . . . , and SW3m2) maybe coupled to input lines of the same control signal. For example, the control electrodes of the second switches (SW12, SW22 . . . , and SW3m2) may be coupled to input lines of the second control signal (Se) supplied from the timing controller 600.

In the exemplary embodiment of FIG. 4, since the pixels 110 disposed in the continuous rows may be sequentially driven, the first control signal (So) and the second control signal (Se) may be alternately supplied so that they do not overlap with each other. For example, each of frequencies of the first control signal (So) and the second control signal (Se) may be set to a second horizontal period and their waveforms may be set to be opposite to each other.

The timing controller 600 may generate a scan drive control signal (SCS), a data drive control signal (DCS), clock signals (CLR, CLG, and CLB) of the data distributor unit 400, and first and second control signals (So and Se) based on externally supplied synchronizing signals. The scan drive control signal (SCS), the data drive control signal (DCS), the clock signals (CLR, CLG, and CLB) of the data distributor unit 400, and the first and second control signals (So and Se), which may be generated in the timing controller 600, may be supplied to the scan driver 200, the data driver 300, the data distributor unit 400 and the switch unit 500, respectively. Also, the timing controller 600 may supply externally supplied data (Data) to the data driver 300.

The above-mentioned method for driving an organic light emitting display device according to one exemplary embodiment will be described in detail below with reference to FIGS. 4 and 5.

FIG. 5 illustrates an exemplary waveform diagram of an exemplary embodiment of a method for driving the organic light emitting display device illustrated in FIG. 4.

Referring to FIG. 5, first and second control signals (So and Se) may be alternately supplied to the switch unit 500 and a scan signal may be sequentially supplied to the scan lines (S0 to Sn) based on a first horizontal period (1H). Clock signals (CLR, CLG, and CLB) may be sequentially supplied to the data distributor 400 during periods when the scan signals are being supplied to the scan lines (S0 to Sn). For example, during the first horizontal period (1H), the clock signals (CLR, CLG, and CLB) may be supplied to the data distributor 400 while the scan signal is being supplied to the first scan line (S1), i.e., the clock signals (CLR, CLG, and CLB) may each have a LOW level while the scan signal is being supplied, i.e., has a LOW level, to the first scan line (S1).

More particularly, the kj^{th} pixel may be reset during a period that a scan signal is supplied to the k-1^{st} scan line (Sk-1).

During such a period, the sub data line (Dj1 or Dj2) coupled to the kj^{th} pixel may be coupled to a corresponding output line (i.e., a j^{th} data line (Dj)) of the data distributor 400 based on a state of the control signal (So or Se). The sub data line (Dj1 or Dj2), to which the kj^{th} pixel is coupled, may be coupled to the data driver 300 based on a state of the clock signal (CLR, CLG or CLB) of the data distributor 400. More particularly, in the exemplary embodiment of FIG. 4, the sub data line (Dj1 or Dj2) to which the kj^{th} pixel is coupled may receive a respective data signal when the respective clock signal (CLR, CLG or CLB) and the respective control signal (So or Se) supplied to the corresponding transistor (M11 to Mm3) and the corresponding switch (SW11 to SW3m2) are at a LOW level. As such, embodiments may enable the sub data line (Dj1 or Dj2) of the kj^{th} pixel to be precharged during a period that a scan signal is supplied to the k-1^{st} scan line (Sk-1).

For example, when k is an odd number, the first sub data line (Dj1), which is coupled to the kj^{th} pixel by way of the clock signals (CLR, CLG, and CLB) of the data distributor 400 and the first control signal (So) of the switch unit 500 during a period that a scan signal is supplied to the k-1^{st} scan line (Sk-1), receives a data signal from the data driver 300 via the data distributor 400 and the switch unit 500. Therefore, the first sub data line (Dj1) coupled to the kj^{th} pixel is precharged during the period that a scan signal is supplied to the k-1^{st} scan line (Sk-1).

Also, when k is an even number, the second sub data line (Dj2), which is coupled to the kj^{th} pixel by way of the clock signals (CLR, CLG, and CLB) of the data distributor 400 and the second control signal (Se) of the switch unit 500 during a period that a scan signal is supplied to the k-1^{st} scan line (Sk-1), receives a data signal from the data driver 300 via the data distributor 400 and the switch unit 500. Therefore, the second sub data line (Dj2) coupled to the kj^{th} pixel is precharged during the period that a scan signal is supplied to the k-1^{st} scan line (Sk-1).

Then, when the scan signal is supplied to the k^{th} scan line (Sk), the kj^{th} pixel may receive a respective data signal via the first or second sub data line (Dj1 or Dj2) that is coupled to the kj^{th} pixel itself.

Embodiments of an organic light emitting display device employing one or more features described above with regard to FIGS. 4 and 5 may enable a respective data signal to be supplied, using, e.g., the data distributor (400) and the switch unit (500), to the respective sub data lines (D11 to D3m2) associated with respective pixels 110 associated with a current scan line (Sk) during a reset period when a scan signal is being supplied to a previous scan line (Sk-1) to reset the pixels 110 to be driven based on the current scan line (Sk).

That is, in some embodiments, continuous rows of pixels may be associated with different ones of the sub data lines (first or second sub data lines) (D11, D12, D21, D22, . . . , D3m1, and D3m2).

Embodiments may provide organic light emitting display devices that may stably drive the pixels 110 during a period when a data signal is precharged in the data lines (sub data lines (D11, D12, D21, D22, . . . , D3m1, and D3m2) associated with some of the pixels and a scan signal is supplied to scan lines associated with others of the pixels, i.e., supply of a data signal for one set of the pixels may overlap with supply of a scan signal for a separate set of the pixels. Therefore, it is possible to stably ensure the driving time of the pixels 110 and the data distributor 400 even when the organic light emitting display device is manufactured in a large size and/or with enhanced resolution.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. An organic light emitting display device, comprising:
a pixel unit including a plurality of pixels;
a data driver adapted to supply a data signal to data lines;
a data distributor, coupled between the data driver and the data lines, adapted to distribute the data signal from output lines of the data driver and respectively output the distributed data signals to the data lines, wherein each of the data lines coupled to the data distributor is coupled to a plurality of sub data lines associated with a corresponding column of the pixels, and
a switch unit coupled between the data lines and the sub data lines and adapted to receive the distributed data signals from the data distributor and selectively output the respective distributed data signal to each of the sub data lines.

2. The organic light emitting display device as claimed in claim 1, wherein the pixels of a same row are coupled to a same respective one of the sub data lines of each of the data lines, respectively, and pixels of adjacent rows are coupled to different respective ones the sub data lines of each of the data lines.

3. The organic light emitting display device as claimed in claim 1, wherein each of the data lines is divided into first and second sub data lines, and rows of the pixels are alternately coupled to the first and second sub data lines.

4. The organic light emitting display device as claimed in claim 1, wherein the switch unit includes a plurality of switches coupled to each of the data lines to selectively couple each of the data lines to the plurality of corresponding ones of the sub data lines.

5. The organic light emitting display device as claimed in claim 1, wherein each of the data lines is divided into first and second sub data lines,
wherein the switch unit includes first switches coupled between each of the data lines and the respective first sub data line; and second switches coupled between each of the data lines and the respective second sub data line.

6. The organic light emitting display device as claimed in claim 5, wherein a frequency of a first control signal to commonly control the first switches and a frequency of a second control signal to commonly control the second switches each are set to a second horizontal period, and the first and second control signals have opposite waveforms.

7. The organic light emitting display device as claimed in claim 1, wherein pixels disposed in a k^{th} (k is an integer) row are coupled to a k^{th} scan line (a current scan line) and a k-1^{st} scan line (a previous scan line), and further coupled to a first one of the sub data lines of each of the data lines, wherein an adjacent upper row and/or an adjacent lower row of the pixels are each coupled to respective ones of the sub data lines of each of the data lines other than the first sub data lines.

8. The organic light emitting display device as claimed in claim 7, wherein the pixels disposed in the k^{th} row are reset when a scan signal is supplied to the k-1^{st} scan line, and receive the respective distributed data signal from the respective sub data lines coupled to the pixels in the k^{th} row when a scan signal is supplied to the k^{th} scan line.

9. The organic light emitting display device as claimed in claim 8, wherein the respective sub data lines coupled to the pixels disposed in the k^{th} row receive the respective distributed data signal from the data driver via the data distributor and the switch unit during a period when a scan signal is supplied to the k-1^{st} scan line.

10. The organic light emitting display device as claimed in claim 1, wherein, for each of the data signals supplied to the data distributor from the data driver, the data distributor distributes the signal into a red data signal to be selectively supplied to a first column of the pixels, a blue data signal to be selectively supplied to a second column of the pixels, and a green data signal to be selectively supplied to a third column of the pixels.

11. An organic light emitting display device including a plurality of scan lines, comprising:
a pixel unit including a plurality of pixels;
data driving means for supplying a data signal to data lines;
data distributing means for distributing the data signal from the data driving means and respectively outputting the distributed data signals to the data lines, wherein each of the data lines is coupled to a plurality of sub data lines associated with a corresponding column of the pixels, and
switching means for receiving the distributed data signal from the data distributor and selectively outputting the respective distributed data signal to each of the sub data lines.

12. The organic light emitting display device as claimed in claim 11, wherein, the switching means enables a first group of the sub data lines to supply the respective distributed data signals to a corresponding first group of the pixels during a same period as when the respective distributed data signals associated with a second group of the pixels are supplied to a second group of the sub data lines associated with the second group of pixels.

13. A method of driving an organic light emitting display device, comprising a plurality of pixels, a plurality of scan lines adapted to receive scan signals and a data distributor, the method comprising:
supplying a data signal,
distributing the data signal and respectively outputting the distributed data signals to data lines, wherein each of the data lines is coupled to a plurality of sub data lines associated with a corresponding column of the pixels, and
selectively supplying the distributed data signals to a first group of the sub data lines associated with a first group of the pixels,
during a same period, supplying a scan signal to a row of the pixels including the first group of pixels and selectively supplying the distributed data signals to a second group of the sub data lines associated with a second group of the pixels.

14. The method as claimed in claim 13, wherein the first group of pixels is a continuous row of pixels and the second group of pixels is another continuous row of pixels that is adjacent to the first row of pixels.

15. The method as claimed in claim 13, further comprising:
during another period, supplying the scan signal to the second group of pixels and selectively supplying the distributed data signals to one of a third group or the first group of the sub data lines that is associated with a third group of pixels.

16. The method as claimed in claim 13, wherein distributing the data signal and respectively outputting the distributed data signals to data lines comprises distributing the data signal in accordance with a plurality of clock signals.
